(19) United States
(12) Patent Application Publication
(10) Pub. No.: US 2019/0139372 A1
(43) Pub. Date: May 9, 2019

(54) GAMING DEVICES WITH COLLECTION FEATURE

(71) Applicant: KING SHOW GAMES, INC., Minnetonka, MN (US)

(72) Inventors: Bradley BERMAN, Minnetonka, MN (US); Jacob LAMB, Maple Grove, MN (US)

(21) Appl. No.: 16/183,620

(22) Filed: Nov. 7, 2018

Related U.S. Application Data
(60) Provisional application No. 62/582,943, filed on Nov. 7, 2017.

(51) Int. Cl. G07F 17/34; G07F 17/32

(52) U.S. Cl. CPC G07F 17/34; G07F 17/3244; G07F 17/3213

(57) ABSTRACT

Embodiments of the present invention set forth systems, apparatuses and methods of operating these devices or systems to provide game play that utilizes operations of collection features in gaming devices. Accordingly, a gaming device can be configured to provide a piggy bank or other collection feature that collects and stores tokens, small credit wins, or bonus icons during game play. At particular intervals, or at a player's choice, the collection can be used, opened, or otherwise cashed-in to reveal awards, multipliers, game event features, to enhance game play on the gaming device.

### RELATED APPLICATIONS

This application claims the benefit of Provisional Patent Application No. 62/582,943, filed on Nov. 7, 2017, to which priority is claimed pursuant to 35 U.S.C. § 119(e) and which is incorporated herein by reference in its entirety.

### FIELD OF THE INVENTION

This disclosure relates generally to games, and more particularly to systems, apparatuses and methods for implementing a collection feature in gaming devices.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes methods, systems, and apparatus that provide for new and interesting gaming experiences, and that provide other advantages over the prior art.

### SUMMARY

To overcome limitations in the prior art described above, and to overcome other limitations that will become apparent upon reading and understanding the present specification, embodiments of the present invention are directed to an apparatus, system, computer readable storage media, and/or method that involve or otherwise facilitate implementing collection features in gaming devices. Gaming devices may include a video display, a memory, a wager input device structured to receive physical items associated with a currency value, and a processor. In embodiments, gaming devices may be configured according to the concepts described herein to improve the function of the gaming devices by providing mechanisms to increase the player enjoyment of the gaming device through a collection and redemption bonus feature. In some embodiments, the collection feature may provide for the collection of items or tokens during game play that can be redeemed or distributed during future game play to enhance player anticipation and enjoyment. In one example embodiment, sub-symbols are associated with symbols on reel strips used on a plurality of gaming reels in the gaming device. If the sub-symbols appear as part of a game outcome in a game grid displayed to the player as a game event result, the sub-symbols may be collected in a collection bin. The sub-symbol items may include credits or multipliers. Once the collection bin receives a predefined number of items, it distributes the values of the collected items during the next gaming event.

### BRIEF DESCRIPTION OF THE DRAWINGS

FIG. 1 is a diagram of a gaming machine according to embodiments of the invention.

FIG. 2 is a block diagram illustrating a computing arrangement according to embodiments of the invention.

FIG. 3 is a detail diagram of a gaming device showing a collection feature according to embodiments of the invention.

FIG. 4 is a detail diagram of a gaming device showing a collection feature according to embodiments of the invention.

FIG. 5 is a detail diagram of a gaming device showing a collection feature according to embodiments of the invention.

FIG. 6 is a detail diagram of a gaming device showing a collection feature according to embodiments of the invention.

FIGS. 7A, 7B, and 7C are detail diagrams of a gaming device showing a game progression using a collection feature according to embodiments of the invention.

FIGS. 8A, 8B, 8C, 8D, and 8E are detail diagrams of a gaming device showing a poker game progression using a collection feature according to embodiments of the invention.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatus.

In various embodiments of the invention, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for implementing customizable bonus features in gaming activities. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. slot game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that utilizes operations of collection features in gaming devices. In one embodiment, a method of operating a gaming device includes providing a piggy bank or other collection feature that collects and stores tokens, small credit wins, bonus icons (from sub-symbols, overlays, game grid, etc.) during game play. At particular intervals, or at a player's choice, the collection can be used, opened, or otherwise cashed-in to reveal awards, multipliers, game event features, bonus spins, etc.

Numerous variations are possible using these and other embodiments of the inventive concept. Some of these embodiments and variations are discussed below with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, or other games of chance. Some of these other types of embodiments will be discussed below as variations to the examples illustrated. However, many other types of games can implement similar techniques and fall within the scope of this inventive concept.

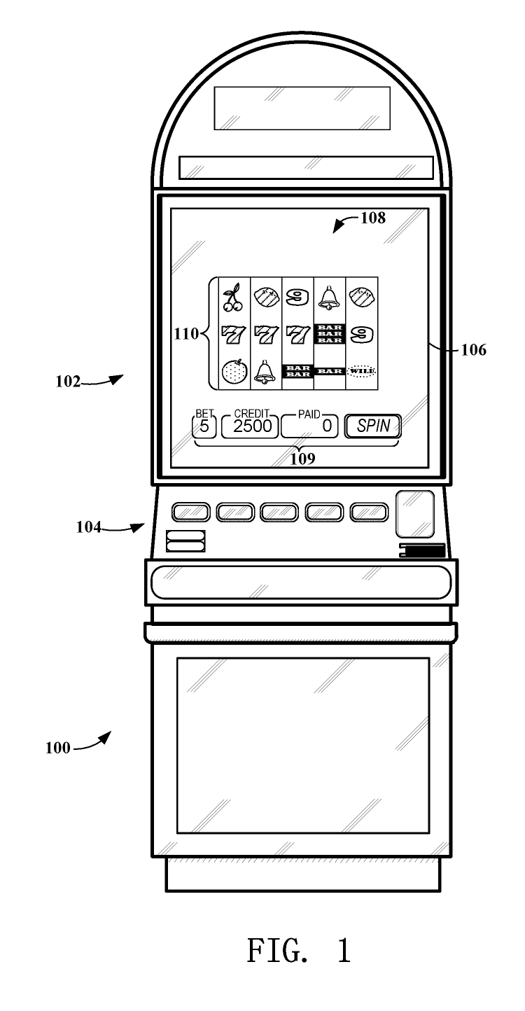

Referring to the example gaming apparatus 100 shown in FIG. 1, the gaming apparatus includes a display area 102 (also referred to as a gaming display), and a player interface area 104, although some or all of the interactive mechanisms included in the user interface area 104 may be provided via graphical icons used with a touch screen in the display area 102 in some embodiments. The display area 102 may include one or more game displays 106 (also referred to as “displays” or “gaming displays”) that may be included in physically separate displays or as portions of a common large display. Here, the game display 106 includes a primary game play portion 108 that displays game elements and symbols 110, and an operations portion 109 that can include meters, various game buttons, or other game information for a player of the gaming device 100.

The user interface 104 allows the user to control and engage in play of the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, or any other user input system or mechanism that allows the user to play the particular gaming activity.

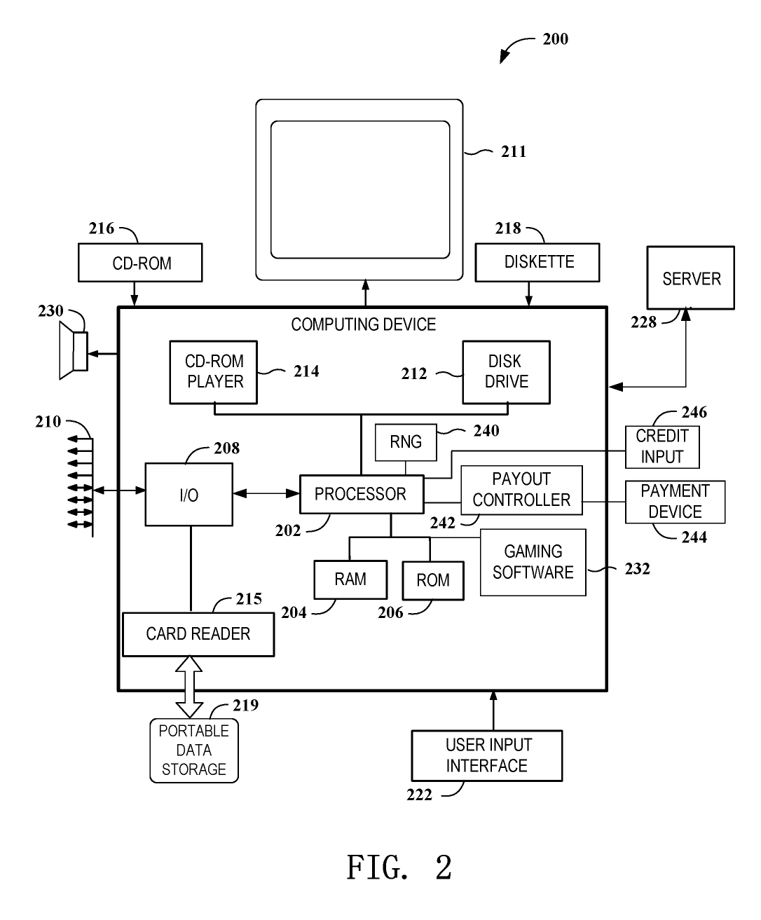

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player loyalty information to identify a user or player of the gaming device. This mechanism may be card reader, biometric scanner, keypad, or other input device. It is through the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as paytable information associated with a glass/plastic panel on the gaming machine 100 and/or graphical images. The symbols or other indicia associated with the play of the game may be presented on an electronic display device or on mechanical devices associated with a mechanical display. Generally, the display 106 devotes the largest portion of viewable area to the primary gaming portion 108. The primary gaming portion 108 is generally where the visual feedback for any selected game is provided to the user. The primary gaming portion 108 may render graphical objects such as cards, slot reels, dice, animated characters, and any other gaming visual known in the art. The primary gaming portion 108 also typically informs players of the outcome of any particular event, including whether the event resulted in a win or loss.

In some the example embodiments illustrated herein, the primary gaming portion 108 may display a grid (or equivalent arrangement) of game elements 110 or game element positions (also referred to as “reel stop positions” herein). As illustrated in the embodiment shown in FIG. 1, the grid includes three rows and five columns of game elements 110, which may form a game outcome of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual symbols, or user controls over stopping or spinning reels. The game display 106 of the display area 102 may include other features that are not shown, such as paytables, navigation controls, etc.

Although FIG. 1 illustrates a particular implementation of some of the embodiments of this invention in a casino or electronic gaming machine (“EGM”), one or more devices may be programmed to play various embodiments of the invention. The present invention may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the invention is illustrated in FIG. 2.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 200 of FIG. 2 is an example computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions in accordance with the present invention typically includes a central processor (CPU) 202 coupled to random access memory (RAM) 204 and some variation of read-only memory (ROM) 206. The ROM 206 may also represent other types of storage media to store programs, such as programmable ROM (PROM), erasable PROM (EPROM), etc. The processor 202 may communicate with other internal and external components through input/output (I/O) circuitry 208 and bussing 210, to provide control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to the display 211, which represents a display on which the gaming activities in accordance with the invention are presented. The display 211 represents the “presentation” of the game information in accordance with the invention, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, or inputting data to identify a player for a player loyalty system. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs may be implemented using hardware, software operable in connection with the processor 202, or some combination of hardware and software. The present invention is operable using any known RNG, and may be integrally programmed as part of the processor 202 operation, or alternatively may be a separate RNG controller 240. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 indicating a payout is to be made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout device 244 may also be provided in gaming machine embodiments, where the payout device 244 serves as the mechanism providing the payout to the player or participant. In some embodiments, the payout device may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, etc., for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payout device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described hereinabove. For example, the software 232 may present, by way of the display 211, representations of symbols to map or otherwise display as part of a slot-based game having reels. However, in other embodiments, the principles of this concept may be applied to poker games or other types of games of chance. One or more aligned positions of these game elements may be evaluated to determine awards based on a paytable. The software 232 may include instructions to provide other functionality as known in the art or as described and shown herein.

As discussed above, embodiments of the present concept include providing gaming devices, gaming systems, and methods of operating these devices or systems to provide features to enhance the game play of gaming events. In some embodiments, the collection feature may provide for the collection of items or tokens during game play that can be redeemed or distributed during future game play to enhance player anticipation and enjoyment.

In one example embodiment, symbols, subsymbols, or overlays may be associated with collectable items that are stored when they appear on the game grid during play of a gaming event. Once a predefined number of items have been collected, a predefined number of gaming events have occurred, a predefined time has elapsed, or another triggering event has occurred (whether random or not), distribution of an award or game modifier may be available for use on future gaming event. In some embodiments, the timing for the distribution, once available, may be selected by the player (i.e., the player may choose when to receive or use the distribution). In other embodiments, the distribution may be automatic when a predefined or random distribution condition is satisfied. In yet some other embodiments, the distribution may occur over multiple future gaming events.

The form of the distribution can vary widely depending on the embodiment implemented in the gaming device. For example, the distribution may include an award amount and/or multiplier associated with the collected items or tokens. In other examples, the distribution may include a multiplier, additional wild symbols added to reels, implementation of symbol stacks, bonus triggers, additional paylines, the expansion of the game grid, locking favorable symbols on the game grid, or other game modifiers that are useable on a future game event. In yet another example, the distribution may take the form of a bonus feature such as a pick bonus, free games, or manipulation of a game board associated with the collection of the items.

In embodiments where the distribution occurs over multiple game events, the contents of the collection bin may be randomly distributed over a predefined or random number of future gaming events. In one example embodiment, after 10 sub-symbols items representing multipliers or credit values have been collected, each of the next 10 gaming events will receive a random one of the items that are distributed from the collection bin. Here, for example, if a credit-award item is distributed, a bonus credit award value will be added to any other awards won during the next gaming event. Alternatively, if a multiplier-value item is distributed, any awards won during the next gaming event will be multiplied by the multiplier value. In another example, a stack of wild symbols may be locked on a randomly chosen reel for the next three gaming events when a distribution triggering condition is satisfied.

In some embodiments, as the player plays, they will randomly be awarded items or tokens. These tokens may go into a collection bin or other virtual container. In some embodiments, the player may cash in their collection. In one example, the tokens may correspond to multipliers and credits values. When cashed in, the sum of credit values in the collection gets multiplied by the sum of the multipliers in the collection. Thus, in this example it may be advantageous for the player to delay cashing in for as long as possible, and/or advantageous for the player to play as long as possible before cashing in.

In other embodiments, tokens could also have modifiers to reel strips that could be combined on the next spin. Here, by collecting the tokens longer, a player may be able to enhance the modifiers and therefore have a better modifier when it is cashed in.

In some embodiments, the collection bin may be shown as type of bank, such as a piggy bank. In some of these embodiments, when the piggy bank is opened, not all items may be used at once. Some items may stay in the bank to keep it seeded. In other embodiments, the piggy bank may only be for presentation purposes. That is, the items presented to the player may be generated by some random algorithm that is not necessarily connected to the tokens. In yet other embodiments, the player may place bonus bets in order to have all small wins (e.g., those wins under a predefined amount) collected in a piggy bank. At random intervals, a presentation will occur in which a random multiplier will be generated and applied to the value in the piggy bank. The resulting sum will be awarded to the player.

In other embodiments, if the player places a bonus bet, each win under some threshold (for example, awards less than the original wager), is not immediately rolled into the players credit meter. Instead it is deposited into a piggy bank until a triggering event occurs. Triggering events could include a sub symbol, an overlay, a reel symbol or a pure mystery trigger. Triggering could also occur when the player has less credits available than the minimum wager needed to play another gaming event. In some embodiments, this may be limited to 1 in 10 spins or more to prevent thrashing. When the triggering event occurs, a multiplier is generated and is applied to the amount in the piggy bank. The resulting amount is then rolled into the players regular credit meter.

In yet other embodiments, a bonus bet may not be required. Instead players could place all wins under a certain threshold into the piggy bank. When the piggy bank reaches a certain amount, the player could “break” it and get a 1 in X chance to win a progressive award (or any other award of similar value, for example a bonus). In some embodiments, the award may be valued at approximately X times the amount in the piggy bank.

In still other embodiments, a collection bin may be embodied as a game board or other active collection environment. In some of these embodiments, a collection game board may include multiple collection locations and multiple possible award locations adjacent to the multiple collection locations. During a distribution sequence (which may be triggered by a distribution condition being satisfied), instead of randomly selecting items to distribute, these embodiments may specify a direction, an action, or other collection-bin mechanism to manipulate the collection bin in order to select one or more collected items and/or award to distribute on one or more future gaming events. In one example embodiment where a collection bin is shown as a labyrinth-styled game board, on each spin, there is a chance that one of two overlay types will appear. The first is a ball overlay. In this case, the player gets a ball added to the labyrinth board at one of the collection locations on the board. That is, ball items can be added at one of X entry points. The ball overlay may be relatively frequent, so the player would normally have multiple balls in the maze at any given time. The other overlay will be a distribution mechanism, which in this embodiment may be a tilt overlay that specifies tilting the board in one of four directions. When the board is tilted all balls on the board move accordingly.

As discussed above, there may be various types of award locations on the game board. In the labyrinth-styled game board, these award locations may be various types of sinks in the board that correspond to particular item awards, such as:

Red—global multiplier on next winning spin

Blue—Convert all F9 symbols to wild for next 4 spins

Yellow—Spin wheel (credits, progressive and bonus trigger)

Green—Add three balls to board

Black—sink, remove ball, no reward

When the ball runs into a sink, it may either be removed from the board (such as in the case of Black), or the corresponding boost is given to the player.

The figures described below illustrate some of the embodiments of this concept. However, many other variations are possible as evidenced by the description above.

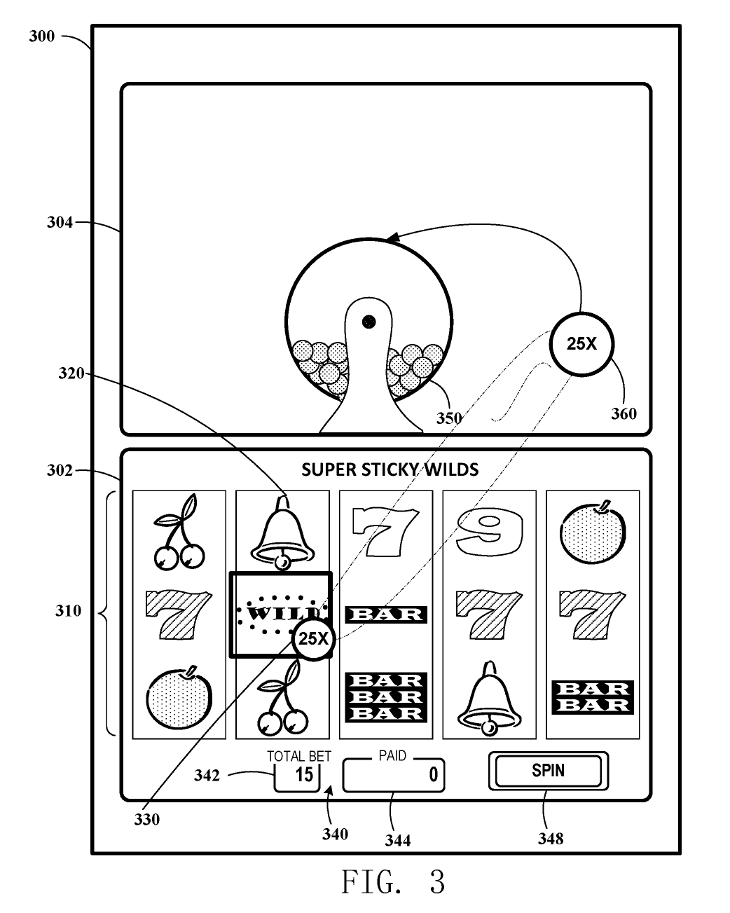

FIG. 3 is a detail diagram of a gaming device showing a collection feature according to embodiments of the invention. Referring to FIG. 3, a gaming device 300 includes a primary display portion 302, a secondary display portion 304. The primary game portion 302 and the secondary display portion 304 may be included in a single video display device, where each of the first display portion and second display portions are areas of the singular video display, which may or may not overlap and/or replace each other during gaming or non-gaming activities. In other embodiments, the primary display portion 302 may be included on a separate video display device from the secondary display portion 304. The gaming device 300 may also include a player interface portion 340, which may appear on either or both of the primary display portion 302 and the secondary display portion 304. The player interface portion 340 may include a variety of buttons, meters, messaging areas, and/or other features that are capable of outputting data to the player or receiving player inputs. The player interface portion 340 of the gaming device 300 illustrated in the embodiment of FIG. 3 includes a Spin button 348, a Total Bet meter 342, and a Paid meter 344. There may, however, be fewer or additional mechanisms included in the player interface portion 340.

In this embodiment, the primary display portion 310 includes a game grid 310 that displays portions of five game reels that each have multiple game symbols 320. A collection bin 350 is shown in the secondary display portion 304. In other embodiments, the collection bin 350 may be displayed in the primary display portion 302, either in addition to the game grid 310 or in alternative views with the game grid. In the embodiment shown in FIG. 3, the collection feature includes sub-symbol overlays 330 that are randomly associated with one or more game symbols 320 prior to or during a gaming event. In this embodiment, the items or tokens 330 may be associated with credit values or multipliers. When one or more of the tokens 330 appear on the game grid 320 as sub-symbol overlays associated with game symbols 320 as part of a game outcome for a gaming event, the token is moved up to a collection area 350 in the secondary display portion 304. In some embodiments, the token may be entered into a collection bin 350 and not independently displayed after being collected. In other embodiments, the token 330 may have a separate item display 360 in the secondary game portion 304 so that the player can keep track of the values of the items or tokens that she has collected during game play. The reminder of the collected items as displayed in the item display 360 may build player anticipation as they know that a near-future distribution condition will cause the distribution of the collected items or awards associated with the collected items over one or more future game events.

Although the embodiment in FIG. 3 shows a sub-symbol overlay 330 as triggering the collection of a token or item, in other embodiments, the presence of certain symbols on the game grid 310 as a result of a gaming event may generate a token for collection. For example, each wild symbol that appears on a game grid as part of a game outcome, may randomly be associated with a token value, each of which may then be collected in the collection bin 350 and/or become part of a collection display 360. In still other embodiments, other triggering conditions may cause the generation and collection of tokens or items.

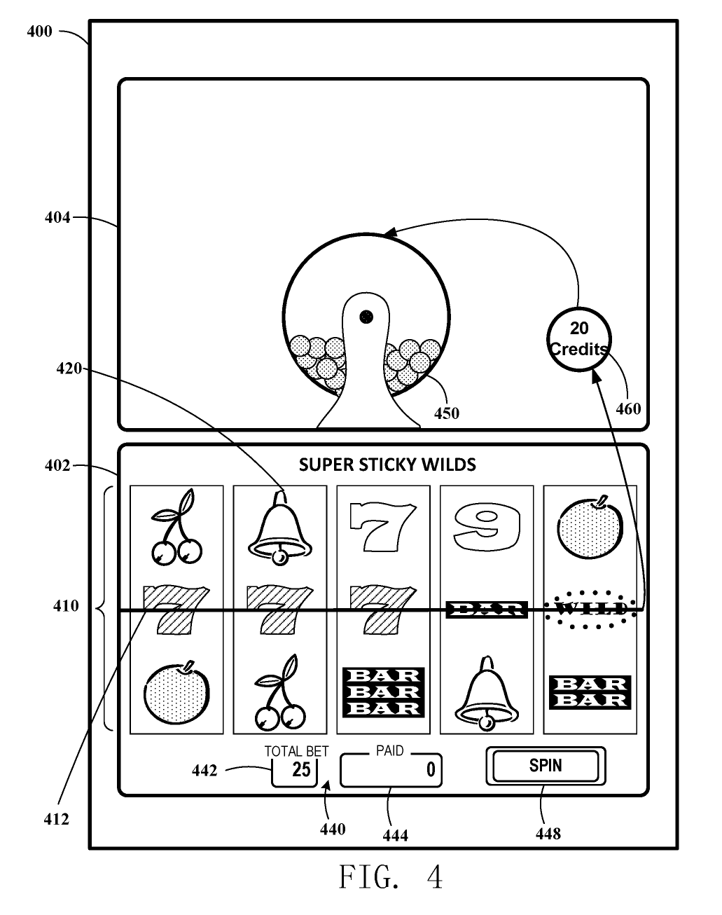

FIG. 4 is a detail diagram of a gaming device showing a collection feature according to embodiments of the invention. Referring to FIG. 4, a gaming device 400 includes a primary display portion 402 with a game grid 410 showing symbols 420 from a plurality of game reels, and a secondary display portion 404 showing a collection area 450. The gaming device may also include a player interface portion 440 that includes various player input devices or output displays, such as a Spin button 448, a Total Bet meter 442 and a Paid meter 444. In the embodiment shown in FIG. 4, a token 460 is generated and collected when a game outcome includes a winning symbol combination along a payline 412, according to a scatter pay, or otherwise according to a paytable. In other embodiments, a token or item may be generated and collected due to other triggering criteria, such as receiving a predetermined number of non-winning game outcomes, the presence of a predetermined number of symbols or sub-symbols on the game grid 410, a mystery bonus being activated, or another triggering condition. In the embodiment shown in FIG. 4 a winning combination of three shaded-7 symbols along a payline 412 triggered the generation of a bonus token 460. The generated bonus token may have a random value (such as the 20 credits shown in FIG. 4) assigned to it or may be based on then the winning outcome. For example, a 3-symbol major symbol winning line combination may generate a bonus token with a randomly selected value between 10 and 25 credits (or it may have a fixed predetermined value, such as 20 credits), a 4-symbol major symbol combination may have an associated bonus token value in the range of 40 to 100 credits, and a 5-symbol major symbol combination may have an associated bonus token value in the range of 200 to 1000 credits. In other embodiments, these ranges of token values may include multiplier values or other game-modifier features, such as a wild-expansion token which when distributed expands any wild symbol on the game grid 410 to fill an entire column of the game grid.

In other embodiments, the token or item generated may be based on an award being less than a predefined value, such as the total wager or cost to cover all paylines. This embodiment could also be shown by FIG. 4 where a line win of three shaded-7 symbols is associated with a 20-credit award, but the wager value was 25 credits as shown in the Total Bet meter 442. Here, since the award value of the win was less than the wager amount, instead of winning the 20 credits and having them immediately paid to the player, the 20 credits get collected and sent to a collection bin (or piggy bank) 450. When a distribution condition is satisfied, all of the credits in the collection bin 450 may be multiplied by a random multiplier and paid to the player. This feature would delay payment of small awards, but with the added incentive that once banked they would be multiplied at a later time to give a larger and more significant award.

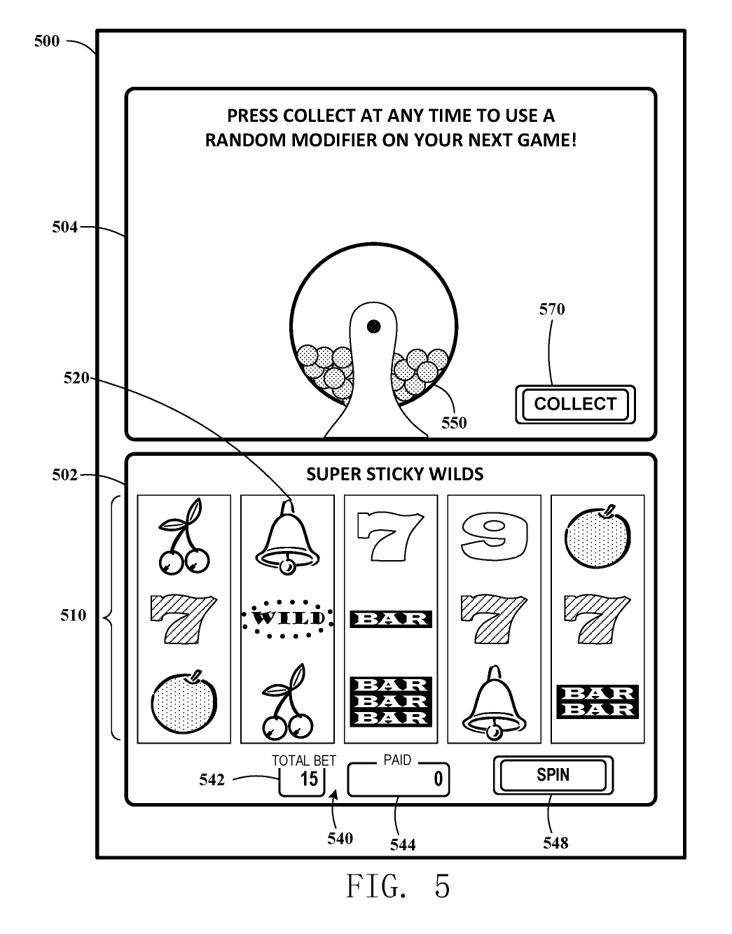

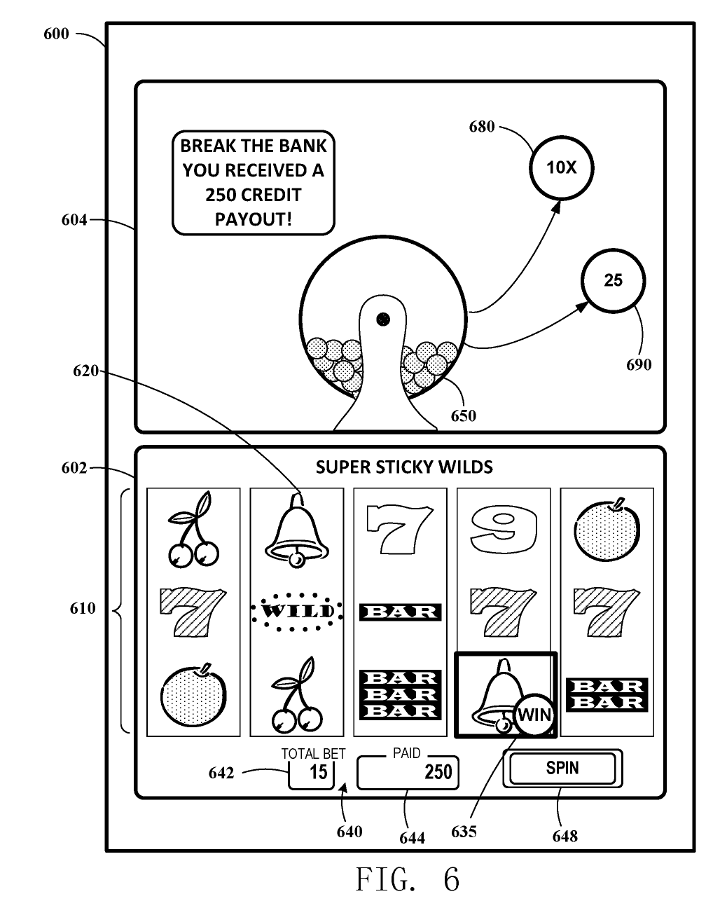

FIGS. 5 and 6 illustrate some of the features that distribution processes may use to distribute awards, modifiers, or other prizes associated with the collected items or tokens.

FIG. 5 is a detail diagram of a gaming device showing a collection feature according to embodiments of the invention. Referring to FIG. 5, a gaming device 500 includes a primary display portion 502 with a game grid 510 showing symbols 520 from a plurality of game reels, and a secondary display portion 504 showing a collection area 550. The gaming device may also include a player interface portion 540 that includes various player input devices or output displays, such as a Spin button 548, a Total Bet meter 542 and a Paid meter 544. In the embodiment shown in FIG. 5, a collection option may become active after a distribution condition is met. The collection option may provide a collection button 570 that a player may activate at any time to have one or more collected items from the collection bin 550 be used in a distribution process.

In some embodiments, the distribution condition may be satisfied when a predefined number of tokens are collected, when a predefined number of games have been played, when the value of the collected items reaches a predefined threshold, when a particular symbol or sub-symbol (or combination of symbols) is received during a gaming event, at a random interval, or according to another defined criterion. In this embodiment, the player may activate the collection button 570 to initiate the distribution process. In some embodiments, that player may have an incentive to not initiate the distribution process immediately. For example, the collected items or values could be treated as an investment that grows or matures the longer it is held in the bank/collection bin 550. In other embodiments, the player may not have any incentive as to when to initiate the distribution process, and can activate it at any time they feel they need a credit boost, feel lucky and want an additional game modifier such as a multiplier, feel that they need a guaranteed win (where they may, for example, get two stacks of wilds on reels 1 and 3), want to leave the gaming device 500, or for any other reason.

FIG. 6 is a detail diagram of a gaming device showing a collection feature according to embodiments of the invention. Referring to FIG. 6, a gaming device 600 includes a primary display portion 602 with a game grid 610 showing symbols 620 from a plurality of game reels, and a secondary display portion 604 showing a collection area 650. The gaming device may also include a player interface portion 640 that includes various player input devices or output displays, such as a Spin button 648, a Total Bet meter 642 and a Paid meter 644. In the embodiment shown in FIG. 6, a distribution process may be triggered when a distribution sub-symbol 635 appears of the game grid 610. In this embodiment, for each distribution sub-symbol 635 that is received on the game grid 610, two previously-collected items 680, 690 are distributed. Here, as only one distribution sub-symbol 635 was received on the gaming grid, two previously-collected items 680, 690 are randomly selected and distributed to the player. In this case, the randomly selected items to be distributed include a 10× token 680 and a 25 credit token 690. The values of these two items 680, 690 are combined and distributed to the player as shown by the 250 credits reflected in the Paid meter 644.

In some embodiments, the game will not place overlay sub-symbols 635 that trigger a distribution on game symbols 620 unless there is a minimum number of items that have been previously collected in the collection bin 650. Additionally, there may need to a minimum number of certain types of symbols in order for the player to be eligible to receive distribution sub-symbol 635. In other embodiments, if the player is distributed two or more different items in the distribution process, these two or more distributed items may interact and be combined to provide a distributed bonus award. For example, if a multiplier item (e.g., “5×”) and a Wild symbol item were distributed during a distribution process, five Wild symbols may be randomly placed on the game grid 610 during the next gaming event or next X number of gaming events. In another example, if a bonus item and a credit item where distributed together during the distribution process, a player may receive 10 free spins, where the value of the credit item is added to any additional awards in each of the free games.

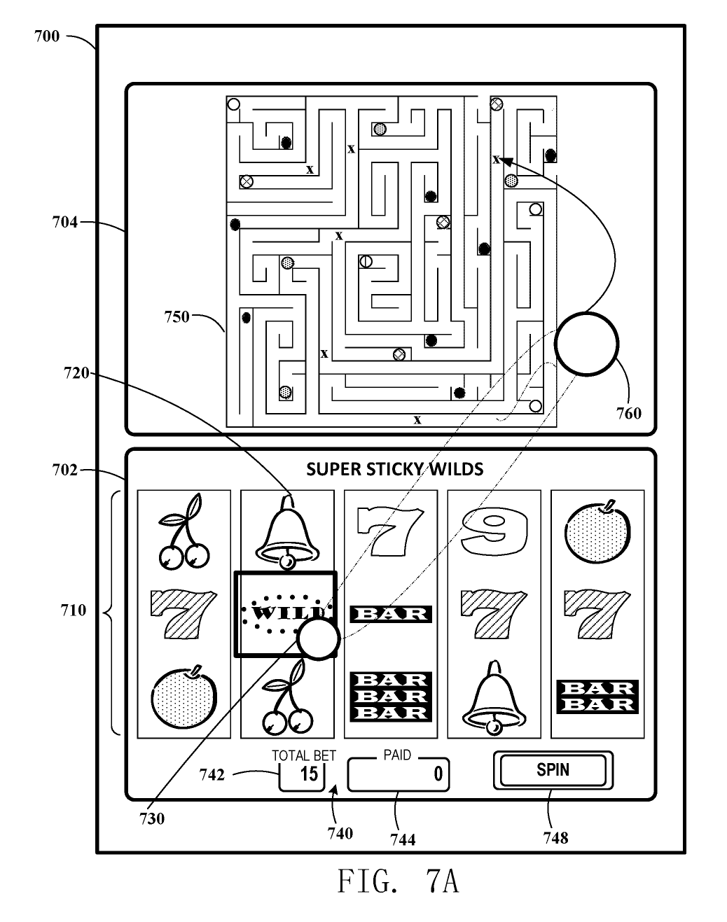

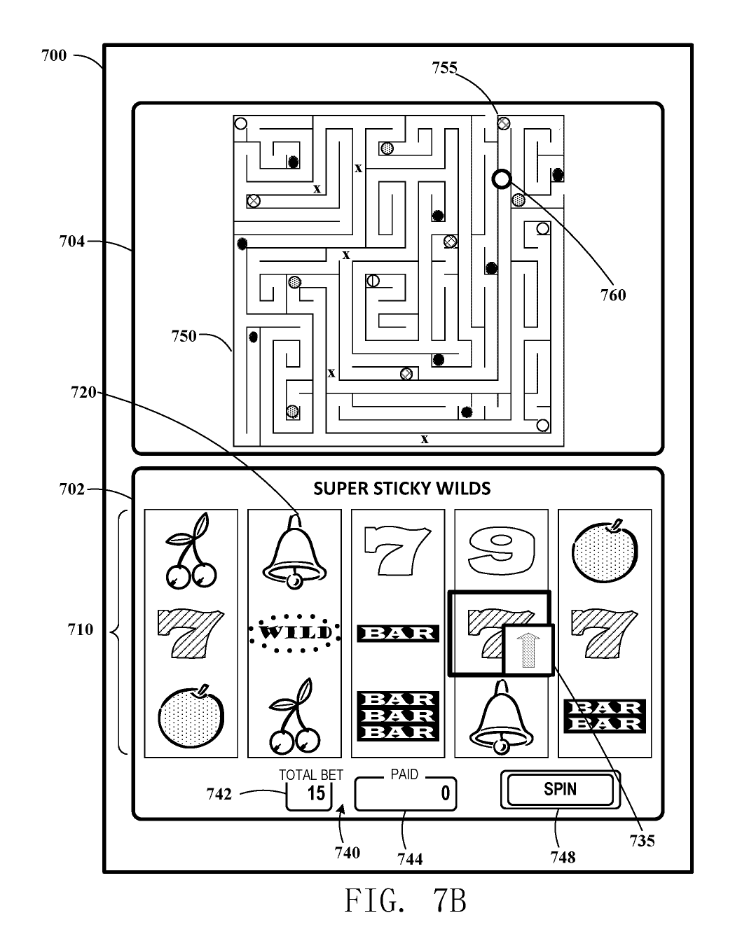

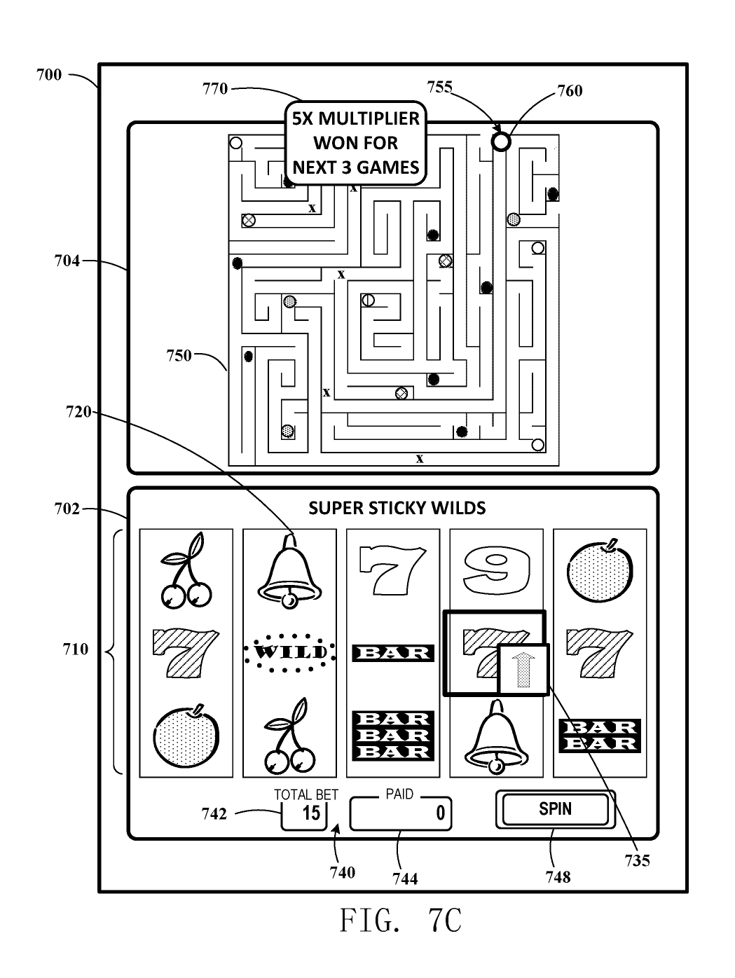

FIGS. 7A, 7B, and 7C are detail diagrams of a gaming device showing a game progression using a collection feature according to embodiments of the invention. Referring to FIG. 7A, a gaming device 700 includes a primary display portion 702 with a game grid 710 showing symbols 720 from a plurality of game reels, and a secondary display portion 704 showing a collection area 750. The gaming device may also include a player interface portion 740 that includes various player input devices or output displays, such as a Spin button 748, a Total Bet meter 742 and a Paid meter 744. In the embodiment shown in FIG. 7, a collection area 750 may include a labyrinth-style game board (or other interactive virtual collection device) that provides for enhanced bonus features that include a variety of nuances. Here, for example, when a sub-symbol overlay 730 appears on the game grid 710, a ball item 760 is randomly placed on one of the entry locations (marked with an “x”) on the collection area 750.

Referring to FIG. 7B, in a subsequent gaming event, a movement item 735 is received as a sub-symbol overlay that directs movement of the collection area 750. Here, the up arrow tilts the game board 750 in the collection area down at the upper end causing the ball item 760 to move in the direction of the up arrow. The result is shown in FIG. 7C where the ball item has landed on a ball sink 755 resulting in an award of a game modifier of “5×” being applied to the next three games. That is, any awards won in the base or primary game of the next 3 gaming events will be multiplied by “5×”.

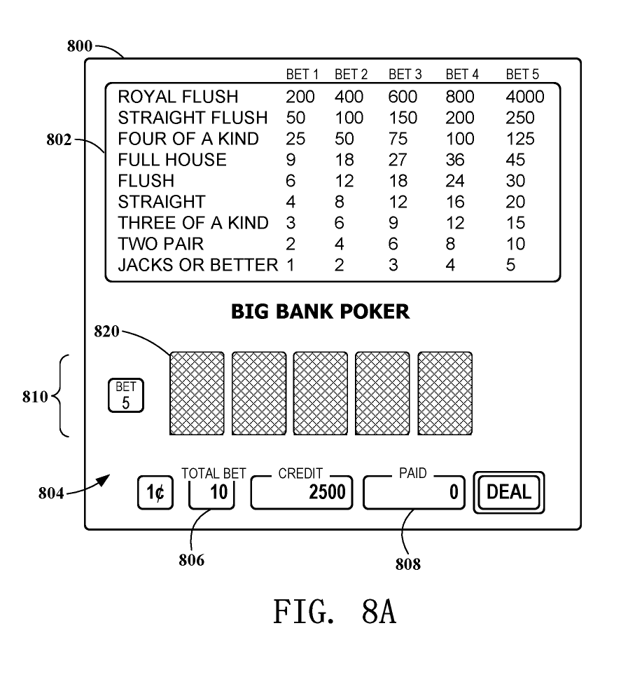

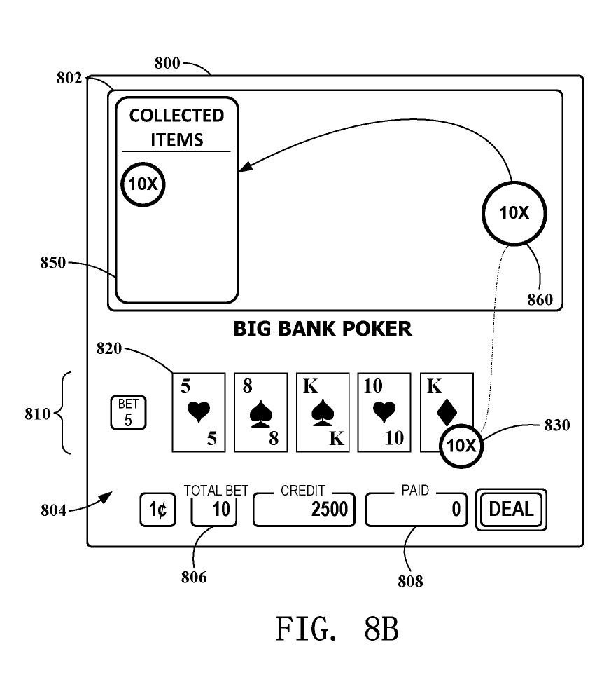

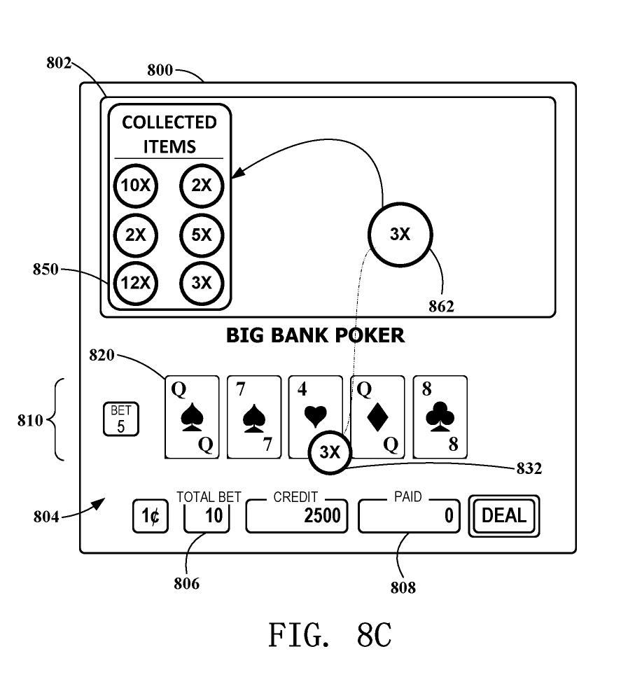

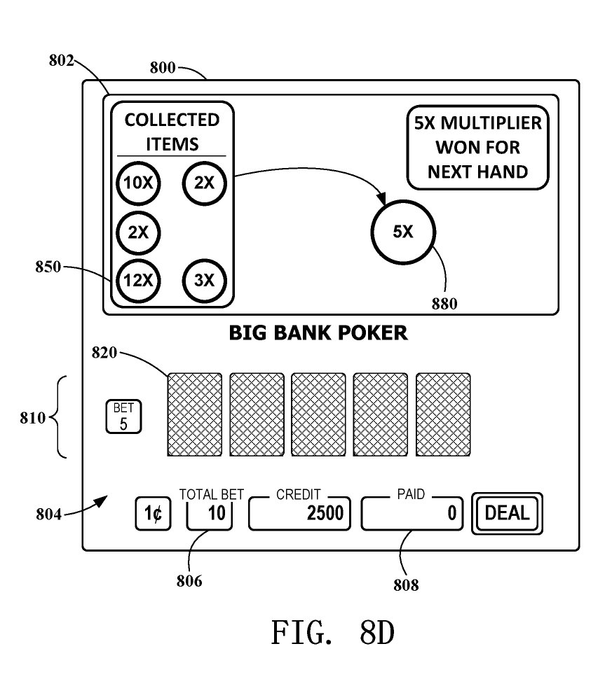

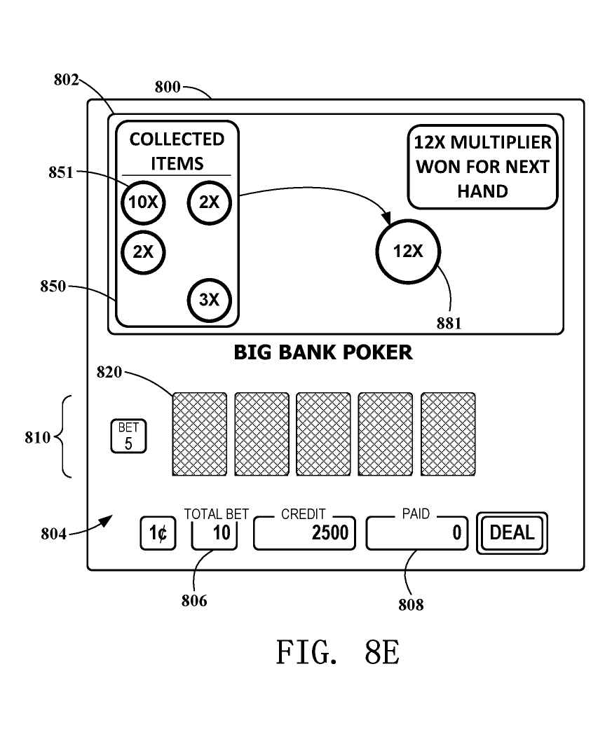

FIGS. 8A, 8B, 8C, 8D, and 8E are detail diagrams of a gaming device showing a poker game progression using a collection feature according to embodiments of the invention. Referring to FIG. 8A, a gaming device having a gaming display 800 includes a game grid 810 having a plurality of card locations where virtual playing cards 820 are dealt to form a poker hand, a secondary display portion 802 that can show various information or bonus features, and a player interface area 804 that may include a variety of player input or output mechanisms such as buttons or meters, which may for example include a Total Bet meter 806 and a Paid meter 808.

Referring to FIG. 8B, during play of a poker game, sub-symbol overlay items 830 may randomly be associated with cards 820 dealt to the poker hand in the game grid 810. In this embodiment, each of the items 860 is associated with a random multiplier value. In some embodiments the random multiplier value may be between “2×” and “20×”. In other embodiments, the items 860 that can be shown as sub-symbol overlays 830 may be associated with credit values, wild cards, split cards, kicker cards, or other bonusing features. In one example, a sub-symbol overlay may be associated with a Joker card that is wild for any other virtual playing card. When the a distribution event occurs, the Joker may be dealt first to the next poker hand, or may be used to replace the least useful card in a dealt poker hand. In another embodiment, a sub-symbol overlay may be associated with a kicker card, such as an Ace or 2, and a distribution event may include receiving quads (4-of-a-kind) during a poker game. If the kicker card had previously been collected, it may be distributed as the kicker card which causes a significantly higher award for the quads.

When one or more sub-symbol overlay items 830 is received in a poker hand (on the deal and/or on draw if it is a draw poker game), the random value of that item 860 is transferred to a collection bin or area 850, where the item is shown. In this embodiment, a distribution event occurs when a player fills the collection bin 850 with collected items 860. In the embodiment shown in this example poker game progression, the collection bin can hold up to six items 860. When the sixth item 860 is received, the distribution event is triggered where the collected items in the collection bin are distributed over the next six poker games. That is, over the next six poker games, any awards won on the poker hand will be multiplied by one of the multiplier values of the stored items. The items may be distributed randomly, or may be distributed according to predefined algorithm, such as a FIFO (First In First Out) or FILO (First In Last Out) system. In other embodiments, different numbers of items 860 may be collected to reach a trigger threshold for distribution, or a different collection or distribution scheme may be used.

Referring to FIG. 8C, after a number of games since the first item 860 was collected, another sub-symbol overlay item 832 is received during a poker game that when collected becomes the sixth item 862 stored in the collection bin 850. As the collection bin 850 is now full, a distribution process is triggered and a random one of the stored items will be distributed over the next six poker games.

Referring to FIG. 8D, a first distributed item 880 is randomly selected from the collection bin 850 and will be applied to any awards won in the next poker game. Referring to FIG. 8E, a second distributed item 881 is randomly selected and from the collection bin 850 and will be applied to any awards won on the poker game after the one where the first distributed item 880 was applied.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out above and in the appended claims.

1. A gaming device comprising:
a video display device configured to display a game grid showing respective portions of a plurality of game reels each having a plurality of game symbols;
a memory device configured to store a credit amount;
a wager input device structured to receive physical items associated with a currency value; and
a processor operable to:
receive a signal from the wager input device indicating receipt of a physical item associated with a currency value;
increase the credit amount stored in the memory based on the currency value of the received physical item;
receive a wager on a gaming event, an amount of the wager deducted from the credit amount stored in the memory;
display a randomly chosen first set of game symbols in the game grid as a primary game outcome of the gaming event;
determine if one or more of the displayed game symbols in the game grid are associated with a token, where each token is associated with an award value;
collect any tokens determined to be associated with game symbols in the game grid, where the collected tokens are stored in a collection area;
determine if a distribution condition is satisfied; and
when the distribution condition is satisfied:
combining at least two award values of tokens stored in the collection area, and
providing the combined award value.

2. The gaming device of claim 1, wherein the award values associated with each token include credit award values.

3. The gaming device of claim 1, wherein the award values associated with each token include multiplier values.

4. The gaming device of claim 1, wherein combining at least two award values of tokens stored in the collection area includes summing the at least two award values when the award values are each credit award values.

5. The gaming device of claim 1, wherein combining at least two award values of tokens stored in the collection area includes multiplying a credit award value with a multiplier value when the at least two award values include a credit value and a multiplier value.

6. The gaming device of claim 1, wherein providing the combined award value includes adding a credit award value to any other awards associated with the game symbols displayed in the game grid as part of the primary game outcome of the gaming event.

7. The gaming device of claim 1, wherein providing the combined award value includes multiplying any other awards associated with the game symbols displayed in the game grid as part of the primary game outcome of the gaming event with a multiplier value.
